(19) United States
(12) Patent Application Publication
(10) Pub. No.: US 2025/0225867 A1
(43) Pub. Date: Jul. 10, 2025

(54) COMPUTER IMPLEMENTED SYSTEM AND METHOD OF ALERTING INDIVIDUALS REGARDING THE APPROACH OF EMERGENCY VEHICLES

(71) Applicant: Elizabeth J. CRAIG, Mackay (AU)

(72) Inventor: Elizabeth J. CRAIG, Mackay (AU)

(21) Appl. No.: 18/841,278

(22) PCT Filed: Jan. 25, 2023
(86) PCT No.: PCT/AU2023/050042

§ 371 Date: Aug. 23, 2024

(30) Foreign Application Priority Data
Feb. 23, 2022 (AU) 2022900413

(51) Int. Cl. G08G 1/0965; G08G 1/005; H04W 4/40; H04W 4/80; H04W 4/90

(52) U.S. Cl. CPC G08G 1/0965; G08G 1/005; H04W 4/40; H04W 4/80; H04W 4/90

(57) ABSTRACT

A computer-implemented method for alerting individuals regarding the approach of one or more emergency vehicles, the method including transmitting, from a first device associated with the emergency vehicle, a short-range signal during travel along a travel path, receiving the short-range signal by a second device associated with an individual travelling along or towards said travel path, and located inside a pre-defined range of the first device, in response to receiving the short-range signal, providing, by the second device, a first alert to the individual regarding the approach of the emergency vehicle thereby enabling the individual to take action to avoid obstructing the emergency vehicle, and providing, by the second device, a second alert to the individual when the individual is no longer in range of the short-range signal.

### FIELD OF THE INVENTION

The present invention relates to a system and method for alerting individuals (e.g. motorists, pedestrians, etc.) travelling along, or towards, a path of travel that corresponds with the travel route of one or more emergency vehicles.

### BACKGROUND OF THE INVENTION

Emergency vehicles, such as ambulances and fire trucks, are vehicles used to respond to emergency incidents. For example, such vehicles are used to drive emergency personnel from a starting location (e.g., a depot) to the location of an emergency (e.g. a residential address, the scene of a vehicle collision, etc), in the shortest possible time. Such vehicles are often required to stop at multiple locations, including in circumstances where an individual needs to be transported from the emergency location to another location (e.g. a hospital). For these reasons, such vehicles need to travel at high speeds and are not subject to the same road rules as other road vehicles. For example, emergency vehicles are typically allowed to travel at speeds that exceed the speed limit assigned to roads along their travel routes. In addition, such vehicles are typically exempted from adhering to traffic light signals and are authorized to carefully navigate through road intersections irrespective of the status of traffic lights at intersections.

In view of the danger that emergency vehicles can pose, i.e. by travelling at high speeds with exemptions regarding conventional road rules, there is a requirement to alert individuals regarding the approach of such vehicles. Generally, this is achieved by the use of a siren mounted to the emergency vehicle. In particular, emergency vehicles utilize sirens that enable nearby individuals (i.e., nearby drivers, pedestrians, etc.) to become aware of an approaching emergency vehicle.

However, there are various disadvantages associated with the use of sirens. For example, sirens are very loud and represent a form of noise pollution, particularly since nearby individuals who are not necessarily in the path of the emergency vehicle have no choice but to be subjected to the siren noise for no other reason than being in the vicinity of the emergency vehicle. Furthermore, due to factors including the speed of the emergency vehicle, the weather conditions, the hearing ability of commuters, the effectiveness of the siren, etc., potentially important details such as the direction of approach of the emergency vehicle, the distance of the emergency vehicle from the individual, the number of emergency vehicles approaching (e.g. a single vehicle or a group of vehicles travelling together), can be difficult to ascertain from a nearby individual's perspective based solely upon the operation of an audible siren.

Sirens are typically also accompanied by warning lights as a visible device for alerting motorists and other individuals in the path of an emergency vehicle. However, flashing warning lights are only effective if individuals are able to directly sight the warning lights on the vehicle or view the flashing lights from a reflection. Warning lights represent a less effective mechanism as compared with the audible sound from the siren, and hence do not solve some of the abovementioned problems associated with sirens.

It will be appreciated that if an individual located in, or moving toward, the path of an emergency vehicle, is equipped with knowledge including the direction of approach of the emergency vehicle, the distance of the emergency vehicle away from the individual and the number of emergency vehicles approaching, the individual will be better placed to take appropriate action to allow free passage of the one or more emergency vehicles. For example, if the individual is a driver of a vehicle in the travel path of an approaching emergency vehicle, the individual may steer their vehicle into another lane, or pull over to the side of the road, in an attempt to avoid their vehicle becoming an obstruction to the approaching emergency vehicle. If the individual is a pedestrian seeking to cross a road in the travel path of the emergency vehicle, the pedestrian may defer crossing the road until after the emergency vehicle has passed.

Relying solely upon the use of a siren or flashing lights to alert individuals regarding an approaching emergency vehicle can result in delayed action by individuals. This can give rise to obstructions in the path of the emergency vehicle, particularly at road intersections, which in turn, can result in the emergency vehicle arriving at their destination later than could otherwise be achieved. It will be appreciated that the late arrival of an ambulance, fire truck, or similar emergency vehicle, can result in the elevation of an emergency and ultimately, additional damage or potential loss of life that may otherwise be avoidable. In addition, improving the ability for individuals to take evasive action reduces the prospects of the emergency vehicle becoming involved in collisions with motorists, which also gives rise to adverse outcomes including the inability to respond to the assigned emergency task, as well as potential injury or death of individuals not involved in the initial emergency for which the emergency vehicle is required.

Some emergency vehicles have the ability to transmit signals to traffic lights (or to traffic light control headquarters) to cause traffic lights in the path of the emergency vehicle to signal red in all directions, or to at least cause the traffic lights to signal red in all directions except for that corresponding with the direction of travel of the emergency vehicle (which will remain green until after the emergency vehicle has passed). However, the use of this technology has the effect of causing significant disruption to the normal flow of traffic (during installation and use), and is cost prohibitive.

Accordingly, there exists a need for a system and method that addresses or at least ameliorates some of the abovementioned problems.

The reference to any prior art in this specification is not, and should not be taken as, an acknowledgement or any suggestion, that the prior art forms part of the common general knowledge.

### SUMMARY OF THE INVENTION

In one aspect, the present invention provides a computer-implemented method for alerting individuals regarding the approach of one or more emergency vehicles, the method including transmitting, from a first device associated with the emergency vehicle, a short-range signal during travel along a travel path, receiving the short-range signal by a second device associated with an individual travelling along or towards said travel path, and located inside a pre-defined range of the first device, in response to receiving the short-range signal, providing, by the second device, a first alert to the individual regarding the approach of the emergency vehicle thereby enabling the individual to take action to avoid obstructing the emergency vehicle, and providing, by the second device, a second alert to the individual when the individual is no longer in range of the short-range signal.

In an embodiment, the first device associated with the emergency vehicle includes a radio-frequency transmitter or a radio-frequency transceiver device.

In an embodiment, the second device associated with the individual includes a radio-frequency receiver or a radio-frequency transceiver device.

In an embodiment, the pre-defined range of the first device extends further than an audible range of a conventional emergency vehicle siren, namely, further than approximately 300 metres (without any obstructions blocking the sound).

In an embodiment, the first device used to transmit the short-range signal is operable from inside a cabin of the emergency vehicle. In one embodiment, the first device is incorporated into the emergency vehicle and is operable by a driver or passenger of the vehicle through the use of an activation switch in the vicinity of the vehicle dashboard. In an alternative embodiment, the first device is a mobile device of the driver or passenger.

In an embodiment, the individual is a driver of a vehicle, and the second device used to receive the short-range signal from the first device is incorporated into the vehicle. For example, the second device may be in the form of an audible and/or visual device associated with the vehicle cabin, configured to provide an audible and/or visual alert to the driver when the short-range signal is received. In an alternative embodiment, the second device is a mobile device of the driver or a passenger of the vehicle configured to provide an audible and/or visual alert when the short-range signal is received by the mobile device.

In another embodiment, the individual is a pedestrian, and the second device is a mobile device of the pedestrian configured to provide an audible and/or visual alert when the short-range signal is received by the mobile device.

In an embodiment, the audible and/or visual alert may include the provision of one or more of a light, voice recording, audible alarm, or alpha-numeric display.

In an embodiment, the signal transmitted by the first device includes an individual signal stamp of a predefined frequency.

In an embodiment, the second device associated with each individual is configured to receive signals at the predefined frequency.

In an embodiment, the individual signal stamp includes an identifier which identifies the particular emergency vehicle from which the signal has been transmitted, thereby enabling each individual within the signal range to recognise when there is more than one emergency vehicle approaching, and in instances when there is more than one emergency vehicle, when each emergency vehicle has passed. In this embodiment, in instances when there is more than one emergency vehicle, the second alert provided to the individual to indicate that they are no longer in signal range of a first emergency vehicle may be different to the second alert provided to the individual to indicate that they are no longer in signal range of a subsequent emergency vehicle.

In an embodiment, the individual signal stamp includes Global Positioning System (GPS) coordinates associated with the emergency vehicle, enabling each individual within signal range to ascertain a position and/or proximity of the emergency vehicle relative to the individual. In an alternative embodiment, the GPS coordinates are transmitted separately from the signal stamp.

In an embodiment, the individual signal stamp includes any additional useful information relating to the emergency vehicle that can be monitored. For example, the individual signal stamp may include the speed and travel direction of the vehicle, enabling the strength and approximate transmission distance of the signal to be determined.

In an embodiment, the individual is detected as no longer in signal range when the signal from the first device is no longer received by the second device.

In an embodiment, the signal is transmitted by the first device in a substantially forward direction relative to a direction of travel of the emergency vehicle, and hence only individuals toward the front of the emergency vehicle will be within signal range. In this embodiment, the individual is detected as no longer in signal range when the individual is located to the rear or side of the emergency vehicle.

In an alternative embodiment, the signal transmission profile is a substantially elliptical shape with the primary axis of the ellipsis substantially co-aligned with the direction of travel of the vehicle such that only individuals to the front and side of the emergency vehicle will be within signal range. In this embodiment, the individual is detected as no longer in signal range when the individual is located to the rear of the emergency vehicle.

In an embodiment, the signal is a continuously transmitted signal.

In an alternative embodiment, the signal is an intermittently transmitted signal.

In an embodiment, the range of the signal is monitored to ensure that if the pre-defined range of the signal is not maintained, one or more actions are taken automatically to increase or decrease the range of the signal transmission.

In an embodiment, monitoring of the signal range is achieved by one or more of calculating a distance between the emergency vehicle and the second devices of individuals who have been detected as just entering into signal range, monitoring the speed and direction of the emergency vehicle, and monitoring the number of obstacles in the path of the signal which may block or reduce the strength of the signal.

In an embodiment, the method further includes operating a central server to communicate with the first and second devices associated with the emergency vehicles and individuals respectively, each device operable to execute a software application that enables communication with the central server.

In an embodiment, the method further includes the central server receiving GPS coordinates associated with each emergency vehicle, and the central server causing the first and/or second devices to display a map or similar graphical representation that depicts the position of the emergency vehicle(s) relative to individual(s) within signal range of the emergency vehicle(s).

In an embodiment, the travel path is a travel route from a first location to a second location, the travel route being predetermined based upon the travel route being the fastest route from the first to the second location.

In an embodiment, the first location is a depot for the emergency vehicle and the second location is the location of an emergency incident.

In an embodiment, the first location is the location of an emergency incident, and the second location is a depot for the emergency vehicle.

In an embodiment, the first location is a location of an emergency incident, and the second location is a location at which any casualties of the emergency incident may be treated.

In a second aspect, the present invention provides a system for alerting individuals regarding the approach of one or more emergency vehicles, the system including a transmitter associated with an emergency vehicle operable to transmit a short-range signal during travel along a travel path, a receiver associated with an individual travelling along or towards said travel path and operable to receive the short-range signal when the individual is located within a pre-defined range of the transmitter, wherein, in response to receiving the short-range signal, the receiver is operable to provide a first alert to the individual regarding the approach of the emergency vehicle to thereby enabling the individual to take action to avoid obstructing the emergency vehicle, and wherein the receiver is operable to provide a second alert to the individual when the individual is no longer within signal range.

In a third aspect, the present invention provides a computer-readable medium that, when executed on a computer, causes one or more processors of the computer to perform the steps of causing a first device associated with the emergency vehicle to transmit a short-range signal during travel along a travel path, causing a second device associated with an individual travelling along or towards said travel path, and located inside a pre-defined range of the first device, to receive the short-range signal, in response to receiving the short-range signal, causing the second device to provide a first alert to the individual regarding the approach of the emergency vehicle thereby enabling the individual to take action to avoid obstructing the emergency vehicle, and causing the second device to provide a second alert to the individual when the individual is no longer in range of the short range signal.

### BRIEF DESCRIPTION OF THE DRAWINGS

Embodiments of the invention will now be described in further detail with reference to the accompanying Figures in which:

FIG. 1 provides an overview of a system according to an embodiment of the present invention showing, in particular, the interaction between various system components.

FIG. 2 illustrates a configuration diagram associated with the server component within the system illustrated in FIG. 1.

FIG. 3 illustrates an exemplary process enabling users to access a software application for interaction with the system illustrated in FIG. 1, including to register their receiving and/or transmitting devices.

FIG. 4 illustrates an exemplary flow diagram associated with the transmission of a short-range signal from an emergency vehicle, and subsequently, based upon receipt of the signal by a motorist, generation of a first alert regarding the approach of the emergency vehicle.

FIG. 5 illustrates exemplary additional interfaces with the software application including an interface for providing a second alert to the motorist once the motorist is no longer within signal range, and various monitoring/diagnostic interfaces.

### DETAILED DESCRIPTION OF EMBODIMENT(S) OF THE INVENTION

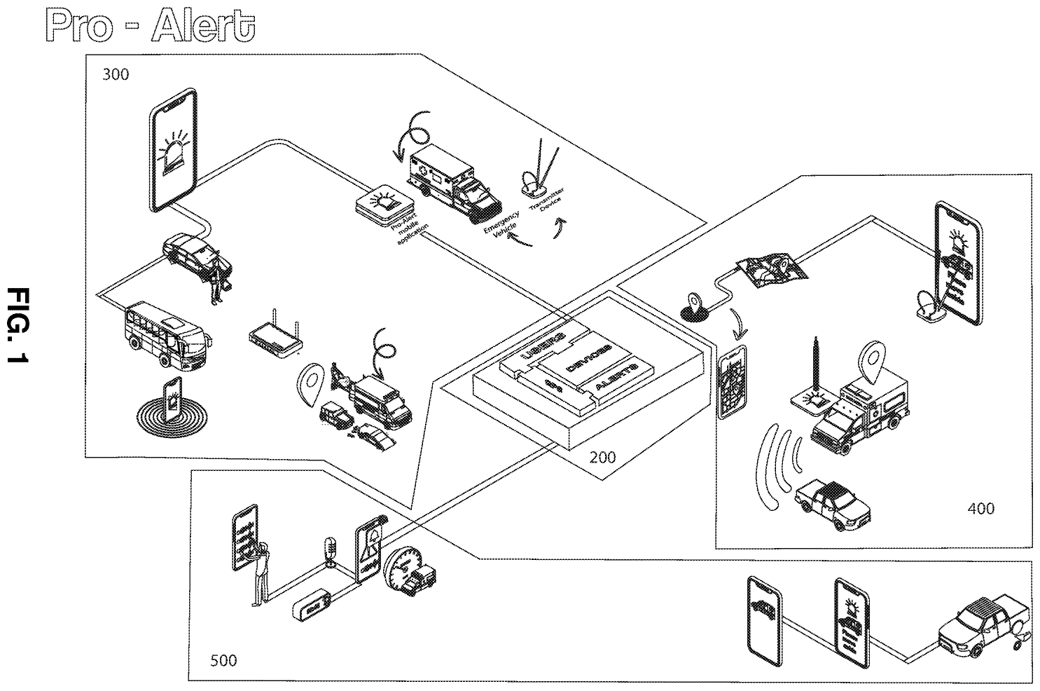

The present invention, according to an embodiment, relates to a system and method for alerting individuals (30) (e.g. motorists, pedestrians, etc) regarding the approach of one or more emergency vehicles (60), as depicted in FIG. 1. In particular, a device (65) associated with the emergency vehicle (60) is configured to transmit a short-range signal (80) during travel along a travel path towards a travel destination (75) (e.g. an emergency location such as a vehicle collision site requiring one or more emergency vehicles such as police and ambulance vehicles). In this way, the short-range signal, which may be in the form of a non-audible radio signal, may be received by devices (50) associated with individuals (30) travelling along or toward the travel path of the emergency vehicle (60) and located inside a pre-defined range of the transmitting device (65).

The device (50) which receives the short-range signal is configured to provide a first alert (90) to the individual (30) regarding the approach of the emergency vehicle (60) to enable the individual to take evasive action thereby avoiding obstructing the emergency vehicle (60). Furthermore, the device (50) is configured to provide a second alert (95) to the individual (30) when the individual (30) is no longer within signal range, i.e. to indicate that they are no longer potentially obstructing the emergency vehicle 60.

The person skilled in the relevant field of technology will appreciate that the system and method described herein provides a solution to existing problems associated with using conventional means to alert motorists and other individuals who are potentially in the path of an emergency vehicle (60) regarding the approach of the emergency vehicle (60). It will become apparent that the system and method is operable to enable individuals (30) to be alerted in advance regarding the approaching vehicle (60), and in a manner that does not disturb others who need not be disturbed regarding the vehicle's approach since they are not moving along or towards the path of the vehicle (60). This allows the emergency vehicle (60) to travel to their destination (75) as quickly and safely as possible, whilst also allowing individuals (30) to evade the vehicle (60) as quickly and safely as possible. The above is achieved with minimal disruption to the normal flow of traffic and pedestrians, and is cost effective since there is no requirement to make changes to existing infrastructure such as traffic lights or other operating infrastructure.

The individuals (30) are also able to obtain additional details regarding the approach of the emergency vehicle (60) which otherwise is not available to the individuals (30), including for example the speed of the vehicle, the direction of approach, the distance of the emergency vehicle (60) from the individual (30), and the number of emergency vehicles (60) approaching. Such detail may provide the individuals (30) with the additional information necessary to more completely understand the likely movements of the emergency vehicles (60).

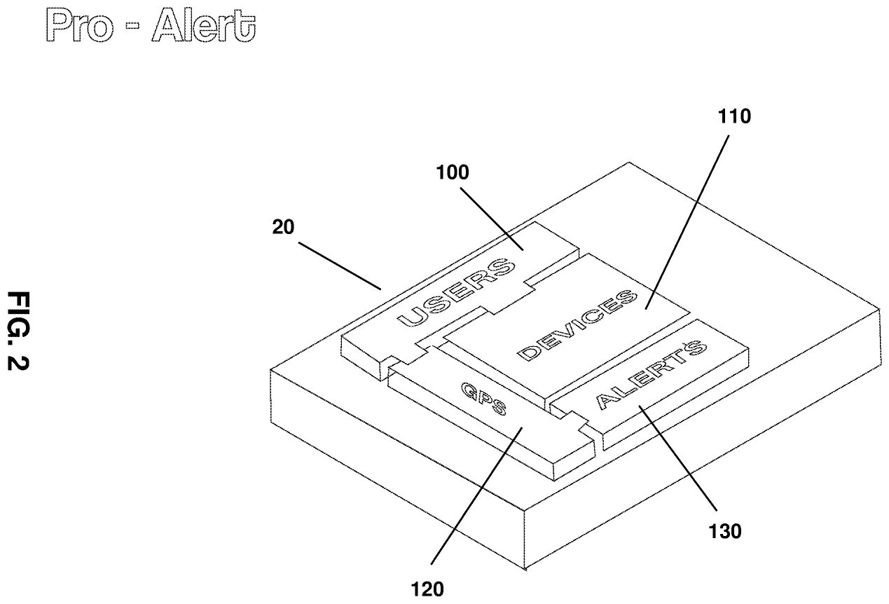

FIG. 2 is divided into segments which are further expanded in subsequent FIGS. 2-5. In particular, segment 200 of FIG. 1 depicts a server component (20) which may be utilised to store information relevant to the individuals (30) as well as the emergency vehicles (60) and their drivers. The server (20) may also be operable to store information relating to the devices (50) associated with the users, and manage the communication of alerts (90, 95) and other information/instructions to relevant devices. For example, a software application (40) operating on data communication devices (50) associated with individuals (30) and drivers of emergency vehicles (60) may be configured to communicate with the server (20). It will be apparent to the person skilled in the relevant field of technology that the software application (40) may be a mobile application or web based application.

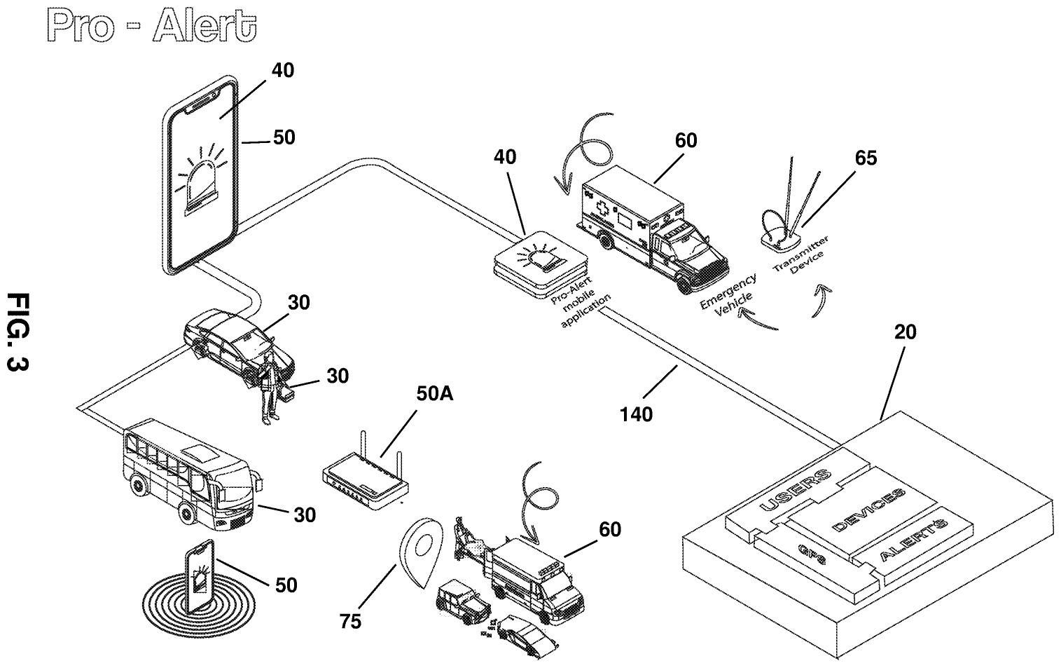

The server component (20) is further detailed in FIG. 2 and the skilled person will appreciate that some of the steps described herein, as executable by the devices (50) may be facilitated by the software application (40) operating on each device (50). Further, whilst the device (50) for receiving the short-range signal (80) from the transmitting device (65) associated with emergency vehicle (60) is depicted as being a mobile device (50) (i.e. the device (50) which an individual (30) may also utilize to access the functionality of the dedicated software application (40)), it will be understood that the device (50) used to receive signals need not necessarily be a mobile device, but could be in the form of any device including devices (50A) configured to be incorporated into a vehicle dashboard, as shown in FIG. 3.

Furthermore, whilst the Figures illustrate device (65) associated with the emergency vehicle (60), it will be understood that drivers and passengers of the emergency vehicles (60) may also operate their own mobile devices to access the software application (40) and its functionality, independently of the device (65). Indeed, as described further below, a mobile device associated with the driver and/or passengers of the emergency vehicle (60) may be the device responsible for transmitting the short-range signal (80).

Segment 300 of FIG. 1 shows how the server (20) may be configured for communication with the receiving devices (50) as well as the transmitting devices (65). In the particular example shown in FIG. 3, the emergency vehicle (60) is travelling to an emergency location (75) in the form of collision site between two vehicles. In this regard, the emergency vehicle (60) upon departure from its existing location (e.g. a depot, hospital, etc) utilises its transmitting device (65) to transmit a short-range signal (80) so that the receiving devices (50) associated with vehicles, pedestrians, etc (30) travelling along or towards a travel path of the emergency vehicle (60) may receive the short-range signal (80) which causes the device (50) to alert the driver, pedestrian, etc (30) regarding the approach of the emergency vehicle (60). This will continue until the emergency vehicle (60) arrives at its destination (75).

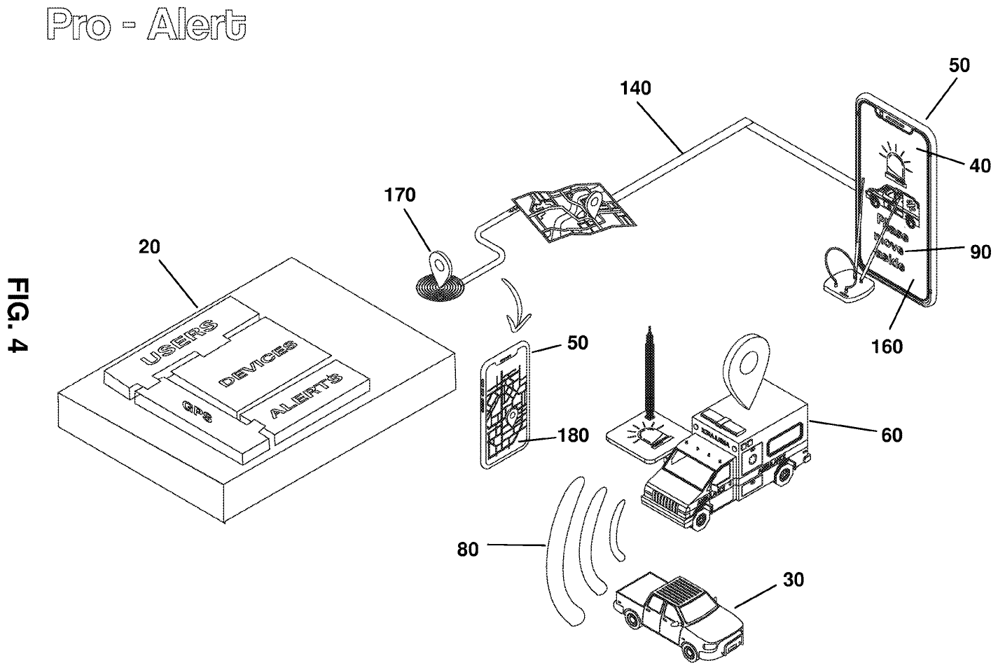

Segment 400 of FIG. 1 shows in greater detail an example of a motorist (30) taking evasive action after receiving the first alert (90) regarding the approach of the vehicle (60), as further detailed in FIG. 4. In particular, the motorist (30) moves to the side of the road to avoid obstructing the emergency vehicle (60). Segment 400 also shows in greater detail the type of information that may be included in the short-range signal (80) transmitted by device (65) associated with the emergency vehicle (60), which is described in greater detail below.

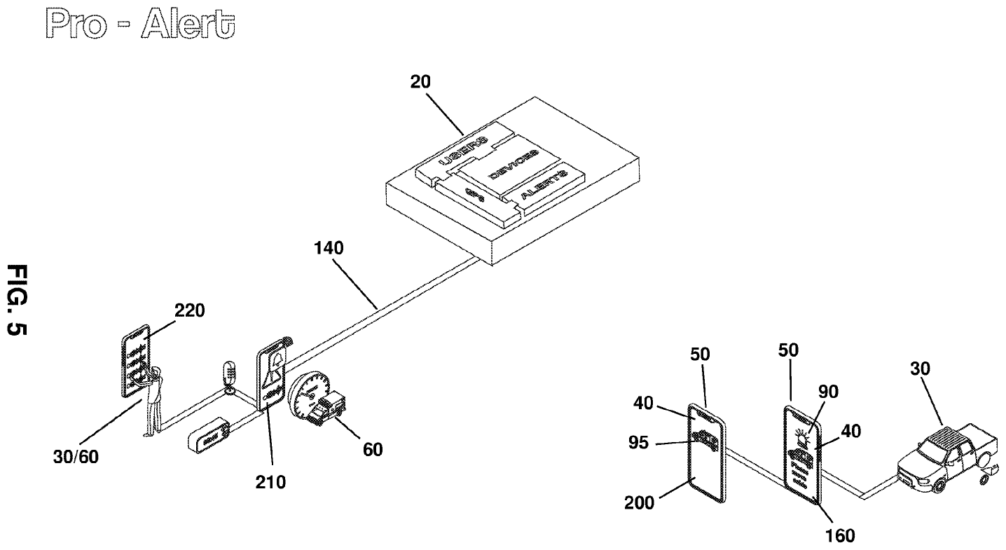

Finally, segment 500 of FIG. 1 shows example interfaces associated with device (50) including an interface for displaying the first alert (90) as described above, as well as a second alert (95) to indicate when the individual (30) is no longer within signal range. The additional interfaces may display information that both the individuals (30) and the drivers/passengers of emergency vehicle (60) may find useful, as further detailed in FIG. 5.

As mentioned above, FIG. 2 shows in greater detail the segment 200 of FIG. 1 and in particular, FIG. 2 shows the server component (20) which may include relevant infrastructure that may be local or cloud-based. The receiving (50) and transmitting (65) devices may include their own individual controllers responsible for managing the transmission of signals during travel and causing the generation of alerts (90,95) to be provided to the individuals (30) at the appropriate times. In an alternative configuration, the server (20) may be configured to carry out all of these steps. In a further alternative embodiment, these steps may be carried out by the server (20) in combination with the devices (50, 65) (i.e. in a distributed architecture). Different arrangements are possible in this regard, but according to a particular implementation of the present invention, the server (20) operates one or more computer processors and maintains one or more databases to enable the following functionality and/or storage:
User account register (100) storing details of all registered users including motorists, pedestrians, etc (30) as well as drivers of emergency vehicles (60) (e.g. name, address, contact details, and any additional detail which may be relevant for the purpose of identifying each user);
Device register (110) storing details relating to registered devices such as mobile phone devices (50) associated with individuals (30) (which may also constitute the receiving device of each individual (30)) and transmitting devices (65) associated with emergency vehicles (60). Identifiers associated with each device, such as serial numbers, may be stored, and any additional information relevant to the devices may also be stored in database (110). For example, the devices (65) associated with emergency vehicles (60) may include a radio-frequency transmitter or a radio-frequency transceiver device, and likewise, the receiving devices (50) associated with individuals (30) may include a radio-frequency receiver or a radio-frequency transceiver device, and details relating to such devices as well as instructional material to operate such devices as well as the software application (40) may be stored in database (110);
Location database (120) storing details relating to, for example, the global positioning system (GPS) coordinates associated with the emergency vehicles (60), and the location of each registered user, i.e. the individuals (30) as well as the drivers of the emergency vehicles (60). It will be appreciated that by monitoring and updating the location information in database (120), additional useful outputs may be generated including the position and/or proximity of the emergency vehicle (60) from the perspective of each individual (30). Database (120) may further include information relating to the signals transmitted from the transmitting devices (65), including details relating to signal stamps associated with each signal, the frequency and range of the signal, and any additional data that may accompany the signal stamp; and
Alerts database (130) storing details relating to alerts (90, 95) presented to individuals (30) including instances of each first alert (90) regarding the approach of the emergency vehicles (60), and instances regarding each second alert (95) provided to individuals (30) which indicate that they are no longer in signal range.

Subsequent Figures also depict that server 20 is configured to enable communication (140) with each of the relevant devices, as previously described.

In the event that individuals (30) as well as others (including for example the drivers of emergency vehicles (60)) use their own personal devices (50) to access the functionality of the software application (40), then it will be necessary for the users to download and install the software application (40). Each of the registered users, whether they be individuals (30) or the drivers of the emergency vehicle (60), may download, install and utilise the software application (40) to access relevant information and/or functionality thereof. For example, individuals (30) may require access to utilize the application (40) to register their receiving devices (50) for storage in database (110), and to subsequently receive signals (80) as well as the first (90) and second (95) alerts. Drivers of emergency vehicles (60) and users tasked with managing such drivers, may also require access to the software application (40) for the purpose of registering their signal transmission device (65) for storage in device database (110). Access may be granted to the registered users after installing the application (40), which may be achieved by downloading the application (40) from an application store. Each registered user may create an account using the application (40) and the account information may be stored in the user account database (100).

In the example shown in FIGS. 3 and 4, an emergency vehicle (60) seeks to travel to an emergency location (75), and motorists, pedestrians, etc (30) who receive a first alert (90) seek to avoid obstructing the emergency vehicle (60) and therefore take evasive action. It will be understood that rather than activating a loud, audible siren, a short-range radio signal may be transmitted from device (65) associated with the emergency vehicle (60) which is silent to others in the vicinity (thereby preventing noise pollution) and will only be recognised by registered individuals (30) who have a device capable of receiving the signal (80) and providing corresponding alerts (90, 95). The typical range of an audible siren is approximately 300 metres, and the signal (80) transmitted by the device (65) may be caused to extend a similar distance or even further in order to have an increased range which would enable pedestrians, motorists etc (30) to potentially take earlier evasive action. Accordingly, an operator of device (65) is afforded increased control over the range and direction of the signal (80).

As described earlier, the device (65) used to transmit the short-range signal (80) may be operable from inside a cabin of the emergency vehicle (60), e.g. incorporated into the vehicle (60) dashboard, and operable by a driver or a passenger of the vehicle through use of an activation switch (not shown) on the vehicle dashboard. Alternatively, the transmitting device (65) may be a mobile device associated with the driver or passenger of the emergency vehicle (60).

The device (50) used to receive the short-range signal may also be incorporated into the vehicle of a motorist (30), or in the case of a pedestrian into any device such as a mobile or smart watch device capable of providing an audible and/or visual alert to users when a short-range signal is received. The audible and/or visual alert may include the provision of one of more of a light, voice recording, audible alarm, and alpha-numeric display.

The travel path of the emergency vehicle (60) to destination (75) may be a travel route that has been calculated as representing the fastest route from the emergency vehicle's current location to the location (75) of the emergency incident. For example, the emergency vehicle (60) may be an ambulance parked at an ambulance depot or hospital, and the travel route may be the fastest route calculated from the depot or hospital to the destination location (75). Once the emergency vehicle (60) arrives at the emergency situation (75) (e.g. to pick up any casualties of the emergency incident), they may also be required to travel at speed to a further location such as a hospital at which any casualties may be treated. Again, the fastest travel route from the location (75) to the further location (e.g. hospital) may be calculated. It will be understood that once a particular travel route has been confirmed for the emergency vehicle (60), the likely route including an indication regarding roads, streets, etc, upon which the emergency vehicle will travel and traffic lights and other obstacles along the way may be published to all registered users (or at least those travelling along or toward the travel path).

As described earlier, the signal transmitted by the devices (65) may include an individual signal stamp of a predefined frequency, and the receiving devices (50) may be configured to receive signals at the predefined frequency. The individual signal stamp may also include an identifier which identifies the particular emergency vehicle (60) from which the signal has been transmitted, thereby enabling each individual (30) within signal range to recognise when there is more than one emergency vehicle approaching, i.e. when more than one identifier has been received (which information may also be provided in the first alert (90)). This is also useful when a second alert (95) is provided to the individuals (30) indicating that they are no longer in signal range, since when there is more than one emergency vehicle (60), the individuals (30) will be able to ascertain once each of the multiple emergency vehicles (60) has passed. In other words, in instances when there is more than one emergency vehicle (60), an individual second alert (95) will be provided once the individual (30) is no longer in range of each respective signal (80). In this regard, the second alerts (95) associated with each passing emergency vehicle (60) may be different in order to enable the individual (30) to differentiate the different emergency vehicle (60).

It will be understood that the GPS coordinates (170) associated with the location of the emergency vehicle (60) may be transmitted separately from the signal stamp, or may be included in the signal stamp. In this way, each individual (30) within signal range may not only be alerted (through receipt of signal (80)) regarding the approach of the emergency vehicle (60), but each individual (30) may also be presented with a visual display (180) indicating the position of the vehicle (60) in an interactive map, and may thereby ascertain, or be presented with, a proximity of the emergency vehicle (60) relative to the individual (30). Further, the individual signal stamp may include additional useful information relating to the emergency vehicle (60), including information arising from monitored data. For example, the speed and travel direction of the vehicle may be monitored, and the individual signal stamp may include the speed and travel direction data which may enable additional outputs to be generated, including in relation to the strength and approximate transmission distance of the signal (80).

The signal (80) may be transmitted by the device (65) in a substantially forward direction relative to a direction of travel of the emergency vehicle (60), and hence only individuals (30) to the front of the emergency vehicle will be within signal range. In this regard, the individual (30) may be detected as no longer in signal range when the individual (30) is located to the rear or side of the emergency vehicle (60). Accordingly, once the emergency vehicle has passed the individual (30), and the individual (30) is located to the rear or side of the emergency vehicle (60) and is thereby out of range of signal (80), the individual (30) is no longer in signal range and the signal (80) is no longer received by the device (50). This may automatically trigger the second alert (95) to be provided to the individual (30) confirming that the emergency vehicle (60) has passed and the individual (30) can carry on walking and/or driving as they were before. Accordingly, unlike the conventional use of an audible siren, individuals (30) who have successfully avoided obstructing and approaching an emergency vehicle (60) by moving to one side of the road (for example) will receive a notification in the form of a second alert (95) confirming that they are no longer in signal range, and hence no longer potentially obstructing the path of the emergency vehicle. In this way, the individuals (30) and others in the vicinity avoid being subjected to the noise of a siren.

In another embodiment, the signal (80) may be transmitted in a substantially 180-degree elliptical shape such that only individuals (30) to the front and side of the emergency vehicle will be within signal range. In this embodiment, the individual (30) will be detected as no longer in signal range once the individual (30) is located to the rear of the emergency vehicle (60).

It will be understood that the transmission of signal (80) may be tailored according to the most appropriate signal direction and/or shape in respect of the particular application or environment. It will be further understood that the signal may be a continuously transmitted signal, or may be a signal transmitted intermittently, again depending upon the particular devices used to transmit and receive the signals as well as the particular environment/application in which the devices are used.

The range of the signal (80) may also be monitored regularly to ensure that a minimum range is always maintained, and in the event that a predefined range is not maintained, one on more actions may automatically increase or decrease the range of the signal transmission (80). For example, monitoring the signal range (80) may be achieved by one or more of calculating a distance between the emergency vehicle (60) and the devices (50) of individuals (30) who have been detected as just entering into signal range, monitoring the speed and direction of the emergency vehicles (60), and monitoring the number of obstacles in the path of the signal (80) which may block or reduce the strength of the signal (80). The manner in which a transmitter device (65) may be operated to increase or decrease the strength of a signal to cause the signal to travel further or shorter distances is known in the art and hence, will not be described in greater detail herein.

FIG. 5 shows in greater detail the various components depicted in segment 500 of FIG. 1 and, in particular, an example interface (160) associated with device (50) in which a first alert (90) is provided to the individual (30), as well as an example interface (200) in which an example of a second alert (95) is provided to the individual (30), i.e. when the individual (30) is detected as no longer in signal range, when the signal from the device (65) is no longer received by their device (50).

FIG. 5 also depicts an example interface (210) associated with device (50), which may be a device operated by any one of the registered users, configured to provide an indication (including substantially in real-time) regarding certain parameters, such as the speed and travel direction of the emergency vehicle (60). Also shown is an example interface (220) which any registered user may access to obtain historical and/or analytical data generated over time, including reports relating to the signal ranges (80) and how they have changed over time, and any other historical and/or analytical data that may be required to assist an administrator or similar user to take actions including authorizing the maintenance of certain hardware such as devices (65) for transmitting signals, as well as whether updates may be required to the software applications (40).

As used herein, the term “server”, “system”, “computer”, “computing system” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms.

The one or more processors as described herein are configured to execute a set of instructions that are stored in one or more data storage units or elements (such as one or more memories), in order to process data. For example, the one or more processors may include or be coupled to one or more memories. The data storage units may also store data or other information as desired or needed. The data storage units may be in the form of an information source or a physical memory element within a processing machine.

The set of instructions may include various commands that instruct the one or more processors to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like.

Optionally, the one or more processors may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in the figures or a described method.

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

1. A computer-implemented method for alerting individuals regarding the approach of one or more emergency vehicles, the method including:
transmitting, from a first device associated with the emergency vehicle, a short-range signal during travel along a travel path;
receiving the short-range signal by a second device associated with an individual travelling along or towards said travel path, and located inside a pre-defined range of the first device;
in response to receiving the short-range signal, providing, by the second device, a first alert to the individual regarding the approach of the emergency vehicle thereby enabling the individual to take action to avoid obstructing the emergency vehicle; and
providing, by the second device, a second alert to the individual when the individual is no longer in range of the short-range signal.

2. A computer-implemented method according to claim 1, wherein the first device associated with the emergency vehicle includes a radio-frequency transmitter or a radio-frequency transceiver device.

3. A computer-implemented method according to either claim 1 or claim 2, wherein the second device associated with the individual includes a radio-frequency receiver or a radio-frequency transceiver device.

4. A computer-implemented method according to any one of the preceding claims wherein the pre-defined range of the first device extends further than an audible range of a conventional emergency vehicle siren.

5. A computer-implemented method according to any one of the preceding claims, wherein the first device used to transmit the short-range signal is operable from inside a cabin of the emergency vehicle.

6. A computer-implemented method according to any one of the preceding claims, wherein the first device is incorporated into the emergency vehicle and is operable by a driver or passenger of the vehicle through the use of an activation switch on the vehicle dashboard.

7. A computer-implemented method according to any one of claims 1 to 5, wherein the first device is a mobile device of the driver or passenger.

8. A computer-implemented method according to any one of the preceding claims, wherein the individual is a driver of a vehicle, and the second device used to receive the short-range signal from the first device is incorporated into the vehicle.

9. A computer-implemented method according to claim 8, wherein the second device is in the form of an audible and/or visual device associated with the vehicle cabin, configured to provide an audible and/or visual alert to the driver when the short-range signal is received.

10. A computer-implemented method according to any one of claims 1 to 7, wherein the second device is a mobile device of the driver or a passenger of the vehicle configured to provide an audible and/or visual alert when the short-range signal is received by the mobile device.

11. A computer-implemented method according to any one of the preceding claims, wherein the signal transmitted by the first device includes an individual signal stamp of a predefined frequency.

12. A computer-implemented method according to any one of the preceding claims, wherein the second device associated with each individual is configured to receive signals at the predefined frequency.

13. A computer-implemented method according to either claim 11 or claim 12, wherein the individual signal stamp includes an identifier which identifies the particular emergency vehicle from which the signal has been transmitted.

14. A computer-implemented method according to any one of claims 11 to 13, wherein the individual signal stamp includes Global Positioning System (GPS) coordinates associated with the emergency vehicle.

15. A computer-implemented method according to any one of claims 11 to 14, wherein the individual signal stamp includes any additional useful information relating to the emergency vehicle that can be monitored, including the speed and travel direction of the vehicle.

16. A computer-implemented method according to any one of the preceding claims, wherein the signal is transmitted by the first device in a substantially forward direction relative to a direction of travel of the emergency vehicle.

17. A computer-implemented method according to any one of claims 1 to 15, wherein the signal transmission profile is a substantially elliptical shape with the primary axis of the ellipsis substantially co-aligned with the direction of travel of the vehicle such that only individuals to the front and side of the emergency vehicle are within signal range.

18. A computer-implemented method according to any one of the preceding claims, the method further including operating a central server to communicate with the first and second devices associated with the emergency vehicles and individuals respectively.

19. A computer-implemented method according to claim 18, wherein the central server receives GPS coordinates associated with each emergency vehicle, and the central server causes the first and/or second devices to display a map or similar graphical representation that depicts the position of the emergency vehicle(s) relative to individual(s) within signal range of the emergency vehicle(s).

20. A system for alerting individuals regarding the approach of one or more emergency vehicles, the system including:
a transmitter associated with an emergency vehicle operable to transmit a short-range signal during travel along a travel path,
a receiver associated with an individual travelling along or towards said travel path and operable to receive the short-range signal when the individual is located within a pre-defined range of the transmitter,
wherein, in response to receiving the short-range signal, the receiver is operable to provide a first alert to the individual regarding the approach of the emergency vehicle to thereby enabling the individual to take action to avoid obstructing the emergency vehicle, and
wherein the receiver is operable to provide a second alert to the individual when the individual is no longer within signal range.

21. A system according to claim 20, wherein the first device associated with the emergency vehicle includes a radio-frequency transmitter or a radio-frequency transceiver device.

22. A system according to either claim 20 or claim 21, wherein the second device associated with the individual includes a radio-frequency receiver or a radio-frequency transceiver device.

23. A system according to any one of claims 20 to 22, wherein the pre-defined range of the first device extends further than an audible range of a conventional emergency vehicle siren.

24. A system according to any one of claims 20 to 23, wherein the first device used to transmit the short-range signal is operable from inside a cabin of the emergency vehicle.

25. A system according to any one of claims 20 to 24, wherein the first device is incorporated into the emergency vehicle and is operable by a driver or passenger of the vehicle through the use of an activation switch on the vehicle dashboard.

26. A system according to any one of claims 20 to 24, wherein the first device is a mobile device of the driver or passenger.

27. A system according to any one of claims 20 to 26, wherein the individual is a driver of a vehicle, and the second device used to receive the short-range signal from the first device is incorporated into the vehicle.

28. A system according to claim 27, wherein the second device is in the form of an audible and/or visual device associated with the vehicle cabin, configured to provide an audible and/or visual alert to the driver when the short-range signal is received.

29. A system according to any one of claims 20 to 28, wherein the second device is a mobile device of the driver or a passenger of the vehicle configured to provide an audible and/or visual alert when the short-range signal is received by the mobile device.

30. A system according to any one of claims 20 to 29, wherein the signal transmitted by the first device includes an individual signal stamp of a predefined frequency.

31. A system according to any one of claims 20 to 30, wherein the second device associated with each individual is configured to receive signals at the predefined frequency.

32. A system according to either claim 30 or claim 31, wherein the individual signal stamp includes an identifier which identifies the particular emergency vehicle from which the signal has been transmitted.

33. A system according to any one of claims 30 to 32, wherein the individual signal stamp includes Global Positioning System (GPS) coordinates associated with the emergency vehicle.

34. A system according to any one of claims 30 to 33, wherein the individual signal stamp includes any additional useful information relating to the emergency vehicle that can be monitored, including the speed and travel direction of the vehicle.

35. A system according to any one of claims 20 to 34, wherein the signal is transmitted by the first device in a substantially forward direction relative to a direction of travel of the emergency vehicle.

36. A system according to any one of claims 20 to 35, wherein the signal transmission profile is a substantially elliptical shape with the primary axis of the ellipsis substantially co-aligned with the direction of travel of the vehicle such that only individuals to the front and side of the emergency vehicle are within signal range.

37. A computer-readable medium that, when executed on a computer, causes one or more processors of the computer to perform the steps of:
causing a first device associated with the emergency vehicle to transmit a short-range signal during travel along a travel path;
causing a second device associated with an individual travelling along or towards said travel path, and located inside a pre-defined range of the first device, to receive the short-range signal;
in response to receiving the short-range signal, causing the second device to provide a first alert to the individual regarding the approach of the emergency vehicle thereby enabling the individual to take action to avoid obstructing the emergency vehicle; and
causing the second device to provide a second alert to the individual when the individual is no longer in range of the short range signal.
